(19) United States
(12) Patent Application Publication
(10) Pub. No.: US 2024/0195656 A1
(43) Pub. Date: Jun. 13, 2024

(54) Detection of an Electric Vehicle Via a Two-Line Bus Termination

(71) Applicant: ABB E-mobility B.V., Delft (NL)

(72) Inventors: Lars Peter Bech, Schiedam (NL); Jim van-der-Heijden, Eindhoven (NL)

(73) Assignee: ABB E-mobility B.V., Delft (NL)

(21) Appl. No.: 18/530,410

(22) Filed: Dec. 6, 2023

(30) Foreign Application Priority Data
Dec. 7, 2022 (EP) 22212063.6

(51) Int. Cl. H04L 12/40; H04L 67/54

(52) U.S. Cl. CPC H04L 12/40013; H04L 67/54; H04L 2012/40215; H04L 2012/40273

(57) ABSTRACT

A method and system for detection of an electric vehicle via a two-line bus includes a detection unit for detecting a presence status of an electric vehicle. The electric vehicle connects to a charger having the detection unit. The detection unit includes a first output for driving a two-line bus, which connects the charger and the electric vehicle; and a first input for receiving signals from the two-line bus. An additional input detects a second bus termination arranged within the electric vehicle through a voltage measurement and/or a current measurement of the two-line bus, wherein detecting the second bus termination is an indication of the presence status of the electric vehicle.

### CROSS-REFERENCE TO RELATED APPLICATIONS

The instant application claims priority to European Patent Application No. 22212063.6, filed Dec. 7, 2022, which is incorporated herein in its entirety by reference.

### FIELD OF THE DISCLOSURE

The present disclosure relates to charging systems for electric vehicles and, more particularly, to a charging system that includes detection of an electric vehicle via a two-line bus.

### BACKGROUND OF THE INVENTION

In at least some cases, an electric vehicle (EV) stays connected (at least mechanically) to an EV charging station even after the charging procedure has been finished. Since a communication on charging issues is no longer required after having charged the EV, at least some EV-to-charger-interfaces are no longer active. Due to this, in at least some situations it is not possible to determine a presence status of the EV after the charging procedure.

### BRIEF SUMMARY OF THE INVENTION

In a general aspect, the present disclosure describes a method or a system for detecting a presence status of an electric vehicle. One aspect relates to a detection unit for detecting a presence status of an electric vehicle. The electric vehicle is configured for connecting to a charger that comprises the detection unit. The detection unit comprises a first output configured for driving a two-line bus, which is to connect the charger and the electric vehicle; a first input configured for receiving signals from the two-line bus. The detection unit further comprises an additional input that is configured for detecting a second bus termination arranged within the electric vehicle by means of a voltage measurement and/or a current measurement of the two-line bus, wherein detecting the second bus termination is an indication of the presence status of the electric vehicle.

### BRIEF DESCRIPTION OF THE SEVERAL VIEWS OF THE DRAWING(S)

FIG. 1 is a schematic diagram of a charging cable arrangement according to an embodiment of the present disclosure.

FIG. 2 is a schematic diagram of a detection system according to an embodiment of the present disclosure.

FIG. 3 is a schematic diagram of a detection system according to an embodiment of the present disclosure.

FIG. 4 is a schematic of a driver capability diagram according to an embodiment of the present disclosure.

FIG. 5 is a schematic diagram of a detection system according to an embodiment of the present disclosure.

FIG. 6 is a flowchart for a method in accordance with the disclosure.

### DETAILED DESCRIPTION OF THE INVENTION

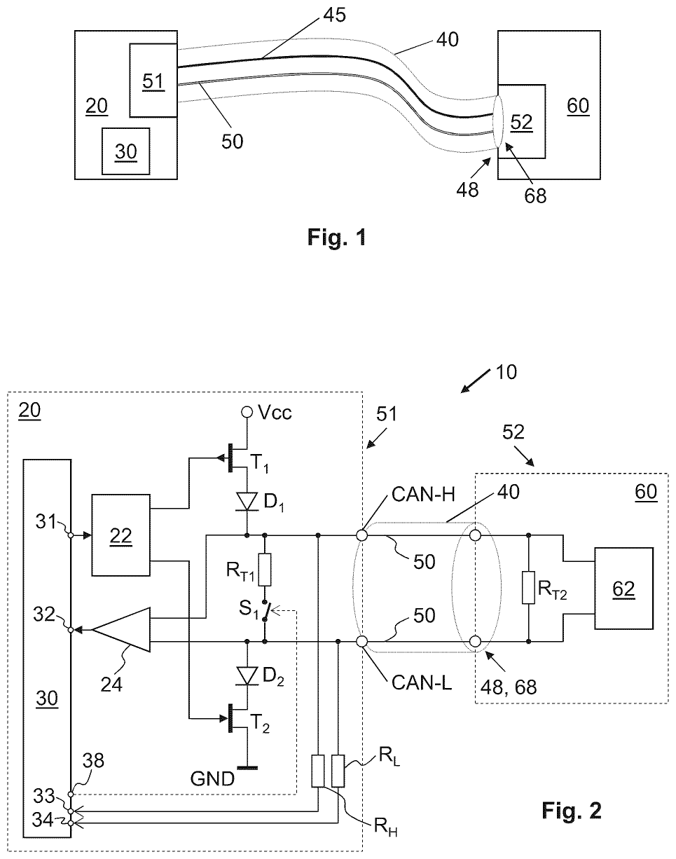

FIG. 1 shows schematically a charging cable arrangement 40 according to an embodiment. The charging cable arrangement 40 connects a charger 20 and an electric vehicle (EV) 60. The charging cable arrangement 40 comprises power cables 45 that provide power for charging the EV. Furthermore, the cable arrangement 40 comprises an electric two-line bus 50, which is configured for exchanging information packets between a first bus instance 51 in the charger 20 and a second bus instance 52 in the electric vehicle 60. The charger 20 may also comprise a detection unit 30. The charging cable arrangement 40 comprises, at its end, a charging connector 48 that fits into a charging socket of the EV 60. FIGS. 2-5 use a CAN bus (Controller Area Network Controller Area Network) as an example for detailed explanations. However, most details also apply to other types of two-line buses.

FIG. 2 shows schematically a detection system 10 according to an embodiment. This embodiment depicts the detection system 10, based on electric specifications of a CAN bus 50. The CAN bus 50 is to connect a charger 20 with an electric vehicle (EV) 60. The CAN bus 50 is arranged within a charging cable arrangement 40 (see FIG. 1). The detection system 10 comprises CAN standard components, such as a driver that drives transistor T1 of the CAN-H line (via diode D1) and transistor T2 of the CAN-L line (via diode D2). The CAN standard components also comprise a receiver 24 for receiving bus signals. For standard operation, a CAN bus termination RT1 and RT2 is arranged within the charger 20 and within the EV 60, respectively. The CAN bus termination RT1 and RT2 is specified as a resistor with 120 ohms. During charging, a charging connector 48 at the end of the charging cable arrangement 40 is connected, via a charging socket 68, to the EV 60, so that power is transferred over power-cables 45 (see FIG. 1) and information packets are transferred over the bus 50. After charging, both the power transfer and the (related) information transfer are turned off. Due to this, detecting the presence status of the EV 60 can no longer be determined based on the information transfer via the CAN bus 50.

Then, the detection system 10 may detect the presence status of the EV 60 by using detection unit 30. The detection unit 30 comprises a first output 31 configured for driving a two-line bus (e.g., the exemplary CAN bus) 50. During charging, the first output 31 may be used for sending information to the bus, and a first input 32 may be used for receiving signals from the bus 50. Furthermore, the detection unit 30 may comprise at least one of additional inputs 33 and 34. The input 33 is connected via a resistor RH to the CAN-H line. The input 34 is connected via a resistor RL to the CAN-L line. Each one of the additional inputs 33 and 34 are configured for measuring a voltage of the CAN-H line or the CAN-L line, respectively. This may be implemented by using two ADC (Analog-to-Digital Converter) channels of a microcontroller. The common mode range of the ADC channels may be large enough to support the expected common mode range. When the CAN bus 50 is driven “dominant” (transmitting a zero), both driver transistors (T1 and T2) will be driven and current will flow through the termination resistors RT1 and RT2. Thus, a voltage difference can be measured between a single termination and a double termination. This may be caused by a certain limited current capability (not ideal switches) of the driver. When the CAN bus is idle (“recessive”, transmitting a one) there will be a certain common mode voltage on the CAN-H and CAN-L signals. This may be biased via high ohmic resistors from both transceivers 22 and 62. A termination will not change this voltage as the termination is in between the CAN signals and not to GND. For detecting a termination, particularly the termination RT2 on the EV 60 side, the TX pin of the transceiver may be driven low. Then, the bus gets status “dominant”, and both driver transistors (T1 and T2) will be active. A current will flow from Vcc through the positive driver transistor T1, through the termination resistor RT1 and then back to GND via the negative driver transistor T2. The driver may have a limited driving capacity (not ideal switches) of typical 60 to 100 mA; cf. FIG. 4. This may also protect the transceiver against short circuit. FIG. 4 shows schematically a driver capability diagram 80 according to an embodiment. A differential voltage between CAN-H and CAN-L may be around 2V with total termination of 60 ohm (both resistors RT1 and RT2 are connected). So, the typical current is around 33 mA. When the termination is only 120 ohms (only one resistor, e.g., RT1, connected), the current will be around 17 mA.

This may be used for detecting the presence status of The EV 60, because detecting the second bus termination RT2 is an indication of the presence status of the electric vehicle 60. Since the current through the bus 50 is limited, a voltage drop over the termination resistors RT1 and RT2 may depend on the resistance the bus 50 is currently terminated with. Thus, it can be determined whether there is 120 ohms, or 60 ohms. In case of 60 ohms, there is an electric vehicle 60 found that can be determined as being connected. This method may be used by any charging system that uses the CAN bus. Examples may comprise CHAdeMO (“CHArge de MOve”), GB (e.g., GB/T charging) and/or ChaoJi. This is for the negative driver, but the positive driver behaves the same. This means that both CAN-H and CAN-L differ 250 mV, so 0.5V together. A threshold of 250 mV is then then the optimum. These numbers may differ over different type of CAN transceivers and temperature. A calibration may be advantageous.

The detection system 10 may, additionally as an option, comprise a switch S1, which may be controlled by a second output 38 of the detection unit 30. The switch S1 may make the CAN termination switchable. When the termination RT1 on the charger 20 side is switched off, detection may be even easier, possibly without a need of calibration. In that case, when no EV 60 (i.e., no RT2) is connected, the current is 0 mA. Then, the voltage difference will double to 1V.

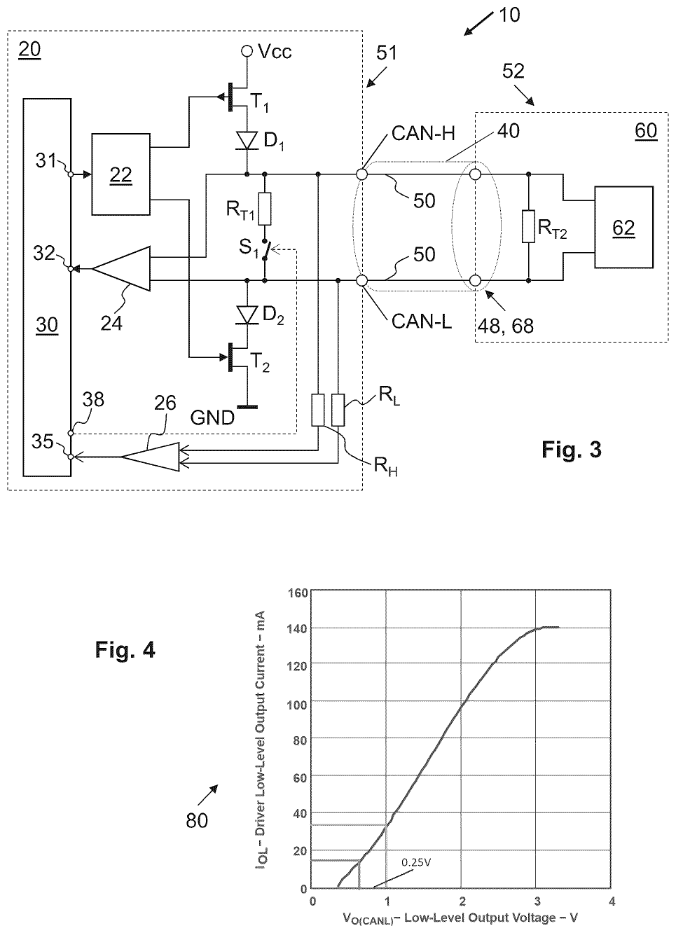

FIG. 3 shows schematically a detection system 10 according to another embodiment. Same reference signs as in FIG. 2 designate similar or the same components. FIG. 3 differs from FIG. 2 essentially by using a differential amplifier 26 for measuring a differential voltage between CAN-H and CAN-L, instead of measuring the voltage from either CAN-H or CAN-L. The differential voltage is forwarded to an additional input 35 of detection unit 30. This embodiment may be able to handle a larger common mode range, and advantageously only one ADC channel is needed instead of two.

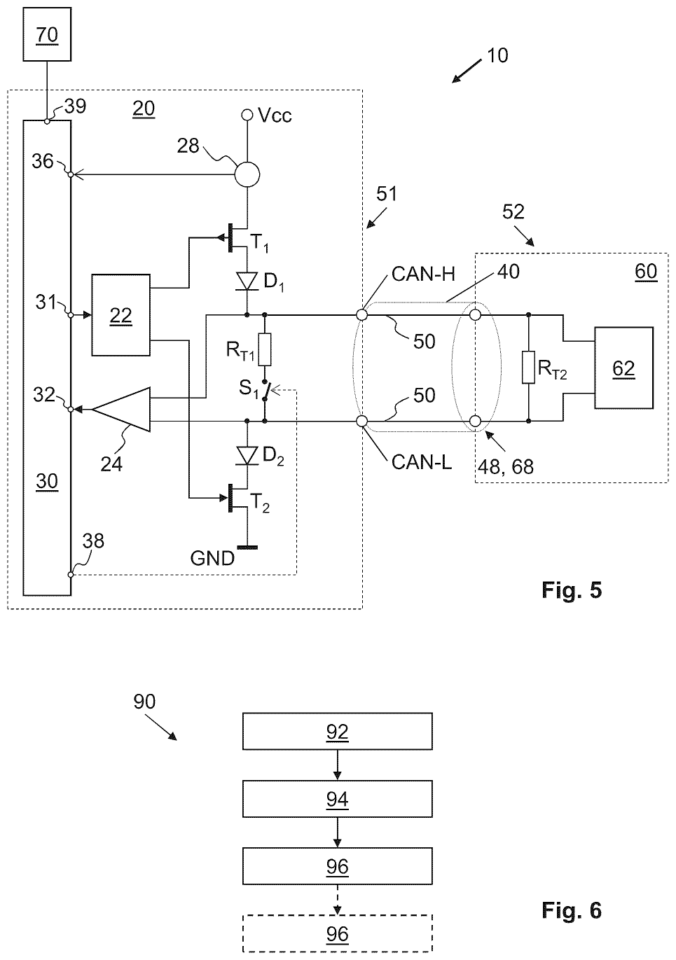

FIG. 5 shows schematically a detection system 10 according to another embodiment. In this embodiment, the detection unit 30 comprises a current measurement unit 28, arranged in series with at least one driving component of the bus driver. The values measured by the current measurement unit 28 are forwarded to an additional input 36 of detection unit 30. This embodiment may advantageously not be sensitive to driver capabilities and variations over temperature, but it may require more components (unless if provided, e.g., in an integrated circuit, FPGA, etc.). The detection unit 30 may further comprise an output to an evaluation unit 70, so that the presence status can be forwarded to the evaluation unit 70, e.g., for further processing, e.g., by a computer.

It should be noted that embodiments of, e.g., FIGS. 2, 3 and 5 can be combined, for instance for plausibility checks and/or for redundancy configurations.

FIG. 6 shows a flow diagram 90 according to an embodiment. In a step 92, an electric bus 50 is paused, wherein the electric bus 50 is configured for exchanging information packets between a first bus instance 51 in a charger 20 and a second bus instance 52 in the electric vehicle 60. The second bus instance 52 may comprise a second bus termination RT2, and the bus 50 may be part of a charging cable arrangement 40. In a step 94, the first bus instance 51 is activated for a detection activation time span. In a step 96, the presence status of the electric vehicle 60 is detected by a detection unit 30, by detecting the second bus termination RT2. In an optional step 98, the presence status of the electric vehicle may be forwarded to an evaluation unit.

The detection unit may be part of a charger and/or, at least partly, a separate unit, e.g., a separate box. The presence status of the electric vehicle may comprise status values “connected/not connected”. Further status values may be possible. The presence status may be forwarded to another system, e.g., to an evaluation unit, which may be a base for lighting a lamp (e.g., for “station occupied”), for storing time data in a database, and/or for further purposes.

The detection unit may be located in a detection system that comprises the two-line bus, which may also be called “computer bus”, “communication bus”, etc., or simply “bus”. The two-line bus may comprise two or more lines; however, only two lines of the bus may be used for the presence status detection. The bus may connect only two bus instances or bus participants, for instance a first bus instance located in the charger and a second bus instance located in the electric vehicle. The bus may be part of a charging cable arrangement, e.g., arranged within housing of a charging cable for delivering electric power to an EV. The second bus instance may comprise a second bus termination, for instance a resistor for terminating the bus. In case a CAN bus is used as the two-line bus, the second bus termination may be a CAN bus termination resistor located in the EV. For other buses, other types of bus termination elements may be used.

The first bus instance may comprise a bus driver that is configured for driving the bus. The bus driver may comprise output transistors that are driven by a processor or controller according to a standardized or a proprietary bus protocol, for example by a CAN controller for driving information transfer packets for a communication on a CAN bus. For detecting the presence status, the communication function of the bus may be deactivated. The detection unit may have means, e.g., a voltage and/or a current measurement unit that is connected to at least one of the bus lines, for detecting the second bus termination. The detection may be based on a comparison with a voltage and/or a current measurement when the second bus termination is connected to the bus, e.g., for a calibration measurement. In at least some buses, the second bus termination is a bus termination resistor. In cases when the second bus termination can be detected, the presence status of the electric vehicle may be set to “connected”. In other cases, the presence status of the electric vehicle may be set to “not connected”.

By performing this, advantageously a method and/or a system is provided for detecting a presence of an electric vehicle, particularly by a unit that may be part of a charger. Moreover, this may even work in phases when the communication connection between the charger and the EV is pausing—e.g., after an end of a charging session and/or if the EV is turned off (“ignition off”)—, because this method does not need to rely on protocol specifics of the bus that is used for the communication. The method may be used for many purposes, e.g., for processing the presence status by means of a computer. Us examples may comprise to determine remotely, e.g., in a building where many charging stations are installed, what charging stations are occupied and which ones are free; this may be a basis for leading a waiting EV to the next free charging station. Also, parking of a car—after the charging process—can be detected, so to inform a waiting car driver and/or to use this information as basis for billing the parking. Furthermore, the information may be used for an automatic start of a charging session or a preparation of a charge session, e.g., as soon an EV is newly plugged to a charging cable of a charger. And it may also be a basis for relieving a power grid, for example in cases when the EV is to be charged overnight, the charging may be started in phases when there is there is redundant power available in the grid.

In various embodiments, the detection unit is only activated when no information packets are transferred over the bus. This particularly makes the method—and a system that realizes this method—independent of protocol specifics of the bus that is used for the communication.

In some embodiments, the detection unit is activated between every 0.1 and 40 seconds, between every 0.5 and 20 seconds, between every 1 and 10 seconds, and/or on demand. The activation frequency may depend on the purpose the method is used for. If, for example, the method is used for billing parking, which is billed by minute, an activation twice per minute may be sufficient.

In some embodiments, the detection activation time span of the detection unit is less than 10 ms, less than 1 ms, less than 0.1 ms. The detection activation time span may depend on the time a measurement device needs for measuring voltage or current, respectively, by the detection unit.

In various embodiments, the bus is a CAN bus (CAN: Controller Area Network), an Ethernet bus, a field bus like Profibus (Process Field Bus), a HART bus (HART: Highway Addressable Remote Transducer), and/or a proprietary bus, and/or a two-line communication bus that is suitable for measuring a second bus termination. Shortly spoken: the method can be applied to all communication channels where a termination—i.e. a termination that corresponds to the described second bus termination—can be measured in a similar way as described above and/or below.

In various embodiments, the first bus instance further comprises a first bus termination, e.g., a bus termination resistor on the charger side. This may be specified by a bus standard and/or may have been decided by a bus designer.

In some embodiments, the first bus termination can be switched on and off. This may be done, for instance, by a semiconductor switch and/or by a relay, etc. This may advantageously improve the detectability the second bus termination.

In some embodiments, the detection unit comprises a first voltage measurement unit, arranged between one of the lines of the two-line bus and ground. In these embodiments, each line of the two-line bus may be used for measuring the voltage against ground, or—e.g. for a plausibility check—both lines may be measured. This kind of measurement may be based on recognizing a voltage drop on at least one of the bus lines as an indication for the second bus termination being (electrically) connected to the bus driver.

In some embodiments, the detection unit comprises a first voltage measurement unit input configured for measuring a first voltage between one of the lines of the two-line bus and ground. In an embodiment, both bus lines may be measured. The measurement may be performed by an ADC (Analog-to-Digital Converter), particularly by an ADC that is integrated in a bus controller.

In some embodiments, the detection unit comprises a second voltage measurement unit input configured for measuring a second voltage between the lines of the two-line bus. The measurement may be performed by an ADC that is connect to an output of a differential amplifier, whose inputs are connected to the lines of the two-line bus. This my increase the sensitivity of the measurement. This embodiment may advantageously not be sensitive to driver capabilities and variations over temperature, but it may require more components, unless if provided, e.g., in an integrated circuit, FPGA (Field Programmable Gate Array), etc.

In some embodiments, the detection unit comprises a current measurement unit input configured for measuring a current in series with at least one driving component—e.g., a driving transistor—of the bus. The detecting may be based on an increased current, in cases when the bus is terminated, compared to cases when the second bus termination is not connected to the bus driver.

In various embodiments, the two-line bus is part of a charging cable arrangement, and/or the charging cable arrangement is pluggable by means of a charging connector into a charging socket of the electric vehicle. For instance, the charging cable may comprise cables that provide power for charging the EV, and within a housing (e.g., a sheath) of the charging cable arrangement, the two-line is arranged along with the power charging cable. The charging cable may comprise, at its end, a charging connector that fits into a charging socket of the EV.

An aspect relates to a detection system for detecting a presence status of an electric vehicle. The system comprises a detection unit as described above and/or below.

An aspect relates to a use of a detection unit or a detection system for detecting a presence status of an electric vehicle, which is at least mechanically connected to a charger, for displaying, for storing and/or for processing by a computer the presence status of the electric vehicle. The computer may be a server, e.g., arranged in a cloud.

An aspect relates to a method for detecting a presence status of an electric vehicle. The method comprises the steps of:
Pausing a two-line bus, which is configured for exchanging information packets between a first bus instance within a charger and a second bus instance within the electric vehicle, the second bus instance comprising a second bus termination;
activating a detection unit within the first bus instance for a detection activation time span; and
detecting, by the detection unit, the second bus termination by means of a voltage measurement and/or a current measurement of the two-line bus, wherein detecting the second bus termination is an indication of the presence status of the electric vehicle.

The pausing may comprise to disconnect a bus controller, wherein the bus controller is configured for exchanging information packets between a charger and an electric vehicle via a two-line bus. This may, e.g., be realized by making the TX pin low (i.e., disconnect it from the CAN controller) from the micro controller that drives the bus for exchanging information between the charger and the EV. In cases when the TX cannot be overruled, a dummy CAN message may be sent with many zeros. For this, an ADC may be selected that is able to sample fast enough.

In some embodiments, the method further comprises the step of: Forwarding the presence status of the electric vehicle to an evaluation unit. They may advantageously be used for a plethora of purposes and/or uses. For instance, in building where many charging stations are installed, it can be determined remotely what charging stations are occupied and which ones are free by sending this information to a computer that displays free and occupied charging lots and/or activates a light, e.g., a red light over an occupied charging lot. Furthermore, the information may be used for an automatic start of a charging session or a preparation of a charge session.

An aspect relates to a computer program product comprising instructions, which, when the program is executed by a computer, cause the computer to carry out the method as described above and/or below.

An aspect relates to a computer-readable storage medium where a computer program or a computer program product as described above is stored on.

It should be noted that two or more embodiments described above and/or below can be combined, as far as technically feasible.

For further clarification, the invention is described by means of embodiments shown in the figures. These embodiments are to be considered as examples only, but not as limiting.

### LIST OF REFERENCE SYMBOLS

10 detection system
20 charger
22 driver
24 receiver
26 differential amplifier
28 current measurement unit
30 detection unit
31 first output
32 first input
36 additional input/unit input
40 charging cable arrangement
45 power cables
48 charging connector
50 bus
51 first bus instance
52 second bus instance
60 electric vehicle (EV)
62 EV transceiver
68 charging socket
70 evaluation unit
80 capability diagram
90 flow diagram
92 steps
D₁, D₂ diodes
R_{L}, R_{H} resistors
R_{T1}, R_{T2} bus termination
S₁ switch
T₁, T₂ driving transistors

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A detection unit for detecting a presence status of an electric vehicle, the electric vehicle configured for connecting to a charger that comprises the detection unit, the detection unit comprising:
a first output configured for driving a two-line bus, which is to connect the charger and the electric vehicle;
a first input configured for receiving signals from the two-line bus; and
an additional input configured for detecting a second bus termination arranged within the electric vehicle by means of a voltage measurement and/or a current measurement of the two-line bus,
wherein detecting the second bus termination is an indication of the presence status of the electric vehicle.

2. The detection unit of claim 1, wherein the detection unit is only activated when no information packets are transferred over the bus.

3. The detection unit of claim 2, wherein the detection unit is activated between one of: every 0.1 and 40 seconds, every 0.5 and 20 seconds, every 1 and 10 seconds, and/or on demand.

4. The detection unit of claim 2, wherein the detection activation time span of the detection unit is less than one of: 10 ms, 1 ms, or 0.1 ms.

5. The detection unit of claim 1, wherein the bus is one of: a CAN bus, an Ethernet bus, a HART bus, a proprietary bus, and/or a two-line communication bus that is suitable for measuring a second bus termination.

6. The detection unit of claim 1, wherein the first bus instance further comprises a first bus termination.

7. The detection unit of claim 5, wherein the first bus termination can be switched on and off.

8. The detection unit of claim 1, wherein the detection unit comprises a first voltage measurement unit input configured for measuring a first voltage between one of the lines of the two-line bus and ground.

9. The detection unit of claim 1, wherein the detection unit comprises a second voltage measurement unit input configured for measuring a second voltage between the lines of the two-line bus.

10. The detection unit of claim 1, wherein the detection unit comprises a current measurement unit input configured for measuring a current in series with at least one driving component of the bus.

11. The detection unit of claim 1, wherein the bus is part of a charging cable arrangement.

12. The detection unit of claim 1, wherein the charging cable arrangement is pluggable via a charging connector into a charging socket of the electric vehicle.

13. A detection system for detecting a presence status of an electric vehicle, the system comprising a detection unit, the detection unit comprising:
a first output configured for driving a two-line bus, which is to connect the charger and the electric vehicle;
a first input configured for receiving signals from the two-line bus; and
an additional input configured for detecting a second bus termination arranged within the electric vehicle by means of a voltage measurement and/or a current measurement of the two-line bus,
wherein detecting the second bus termination is an indication of the presence status of the electric vehicle.

14. A method for detecting a presence status of an electric vehicle, the method comprising:
pausing a two-line bus configured for exchanging information packets between a first bus instance within a charger and a second bus instance within the electric vehicle, the second bus instance comprising a second bus termination;
activating a detection unit within the first bus instance for a detection activation time span; and
detecting, by the detection unit, the second bus termination by utilizing a voltage measurement and/or a current measurement of the two-line bus, wherein detecting the second bus termination is an indication of the presence status of the electric vehicle.

15. The method of claim 14, further comprising forwarding the presence status of the electric vehicle to an evaluation unit.

16. The method of claim 13, wherein the detection unit is activated between one of: every 0.1 and 40 seconds, every 0.5 and 20 seconds, every 1 and 10 seconds, and/or on demand.

17. The method of claim 13, wherein the detection activation time span of the detection unit (30) is less than one of: 10 ms, 1 ms, or 0.1 ms.
